(19) United States
(12) Patent Application Publication
(10) Pub. No.: US 2020/0272883 A1
(43) Pub. Date: Aug. 27, 2020

(54) REWARD-BASED UPDATING OF SYNPATIC WEIGHTS WITH A SPIKING NEURAL NETWORK

(71) Applicant: INTEL CORPORATION, Santa Clara, CA (US)

(72) Inventors: Yongqiang CAO, Portland, OR (US); Andreas WILD, Portland, OR (US); Narayan SRINIVASA, Portland, OR (US)

(73) Assignee: INTEL COPORATION, Santa Clara, CA (US)

(21) Appl. No.: 16/646,494

(22) PCT Filed: Dec. 19, 2017
(86) PCT No.: PCT/US17/67399

§ 371 Date: Mar. 11, 2020

(51) Int. Cl. G06N 3/04; G06N 3/08

(52) U.S. Cl. CPC G06N 3/049; G06N 3/08

(57) ABSTRACT

Techniques and mechanisms to update a synaptic weight of a spiking neural network which is trained to provide a decision of a decision-making sequence. In an embodiment, a synapse of the spiking neural network is associated with a weight which is to be given to communications via that given synapse. The spiking neural network generates output signaling, indicating a decision to the decision-making process, which is evaluated to determine whether, according to predefined test criteria, the decision-making process is successful or unsuccessful. One or more nodes of the spiking neural network receive a reward/penalty signal which is based on the evaluation. In response to the reward/penalty signal indicating a reward event or a penalty event, a synaptic weight value is updated. In another embodiment, input signaling provided to the spiking neural network represents a sub-sequence of two or more most recent states in a sequence of states.

### BACKGROUND

Embodiments described herein generally relate to spiking neural networks, and more particularly, but not exclusively, relate to techniques for determining a synaptic weight value.

A variety of approaches are currently used to implement neural networks in computing systems. The implementation of such neural networks, commonly referred to as “artificial neural networks”, generally include a large number of highly interconnected processing elements that exhibit some behaviors similar to that of organic brains. Such processing elements may be implemented with specialized hardware, modeled in software, or a combination of both.

Spiking neural networks (or “SNNs”) are increasingly being adapted to provide next-generation solutions for various applications. SNNs variously rely on signaling techniques wherein information is communicated using a time-based relationship between signal spikes. As compared to typical deep-learning architectures—such as those provided with a convolutional neural network (CNN) or a recurrent neural network (RNN)—a SNN provides an economy of communication which, in turn, allows for orders of magnitude improvement in power efficiency.

Neural networks are configured to implement features of “learning”, which generally are used to adjust the weights of respective connections between the processing elements that provide particular pathways within the neural network and processing outcomes. Existing approaches for implementing learning in neural networks have involved various aspects of unsupervised learning (e.g., techniques to infer a potential solution from unclassified training data, such as through clustering or anomaly detection), supervised learning (e.g., techniques to infer a potential solution from classified training data), and reinforcement learning (e.g., techniques to identify a potential solution based on maximizing a reward). However, each of these learning techniques are complex to implement, and extensive supervision or validation is often required to ensure the accuracy of the changes that are caused in the neural network.

### BRIEF DESCRIPTION OF THE DRAWINGS

The various embodiments of the present invention are illustrated by way of example, and not by way of limitation, in the figures of the accompanying drawings and in which:

FIG. 1 shows diagrams each illustrating features of a simplified neural network according to an embodiment.

FIG. 2 is a flow diagram illustrating elements of a method to determine a value of a synaptic weight of a spiking neural network according to an embodiment.

FIG. 3 shows a circuit diagram and a timing diagram variously illustrating elements of a signaling to determine a value of a synaptic weight according to an embodiment.

FIG. 4 shows a state diagram and a functional block diagram variously illustrating features of a spiking neural network to perform a binary decision making process according to an embodiment.

FIG. 5 shows timing diagrams illustrating results of a binary decision making process performed with a spiking neural network according to an embodiment.

FIG. 6 is a functional block diagram illustrating a computing device in accordance with one embodiment.

FIG. 7 is a functional block diagram illustrating an exemplary computer system, in accordance with one embodiment.

### DETAILED DESCRIPTION

Embodiments described herein variously provide techniques and mechanisms for determining (e.g., updating) the value of a weight which is assigned to a synapse of a spiking neural network. During operation of the spiking neural network, such a value (also referred to herein as a “synaptic weight value” or, for brevity, “weight value”) may applied to a signal which is communicated via the synapse.

As used herein, “input node” refers to a node by which a signal is received at a spiking neural network. The term “output node” (or “readout node”) refers herein to a node by which a signal is communicated from a spiking neural network. The term “input signaling” refers herein to one or more signals (e.g., including one or more spike trains) which are variously received each at a respective input node of a spiking neural network. The term “output signaling” refers herein to one or more signals (e.g., including one or more spike trains) which are variously communicated each from a respective output node of a spiking neural network. The term “spiked input signals” is also used herein to refer to one or more input spike trains, where “spiked output signals” similarly refers to one or more output spike trains. The term “reward/penalty signal” refers herein to a signal which indicates, based on an evaluation of output signaling from a spiking neural network, whether some processing performed with the spiking neural network has, according to predefined test criteria, been successful (or alternatively, unsuccessful). “Trace” refers herein to a variable—e.g., represented as a signal or stored data—which may change over time due, for example, to signal activity which is detected at a given node. The term “eligibility trace” refers more particularly to a trace which indicates a sensitivity of some value (e.g., that of some other trace or signal) to change in response to a different value (e.g., that of yet another trace or signal). For example, an eligibility trace may represent a susceptibility of given trace, weight or such other parameter to being changed in response to another parameter. In one example embodiment, such a sensitivity/susceptibility may be represented as a value which is equal to, or otherwise based on, a product of the respective values of the eligibility trace and the other parameter. However, any of a variety of other functions may be used to determine such a level of sensitivity/susceptibility.

In some embodiments, operation of a spiking neural network includes the communication of various spike trains each via a respective synapse coupled between two corresponding network nodes—e.g., wherein such communication is in response to input signaling received by the spiking neural network. Such communications may result in the spiking neural network providing output signaling which is to provide a basis for subsequent signaling which updates one or more synaptic weight values. For example, the output signaling may be evaluated to determine whether (or not) a satisfaction of some predefined test criteria is indicated. Based on such evaluation, one or more reward/penalty signals may be communicated each to and/or within the spiking neural network—e.g., wherein one such reward/penalty signal is provided to at least one node which participated in the earlier communication of various spike trains. Based on such reward/penalty signaling, one or more synaptic weight values of the spiking neural network may be updated.

A spiking neural network according to some embodiment may be operable to facilitate the determining of a sequence of states (or “state sequence”)—e.g., wherein the spiking neural network implements at least in part a finite state machine (FSM) which includes such states and multiple transitions each from a respective current state to a respective next state. Successive evaluations, each for a corresponding processing stage performed with such a spiking neural network, may each detect whether processing performed to-date is successful (or unsuccessful), according to some predefined test criteria. Based on the evaluations, successive rounds of synaptic weight updates may be performed—e.g., wherein such updating rounds facilitates training of the spiking neural network to identify an efficient state sequence that satisfies the predefined test criteria.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. Such devices may be portable or stationary. In some embodiments the technologies described herein may be employed in a desktop computer, laptop computer, smart phone, tablet computer, netbook computer, notebook computer, personal digital assistant, server, combinations thereof, and the like. More generally, the technologies described herein may be employed in any of a variety of electronic devices to update a synaptic weight value of a spiking neural network.

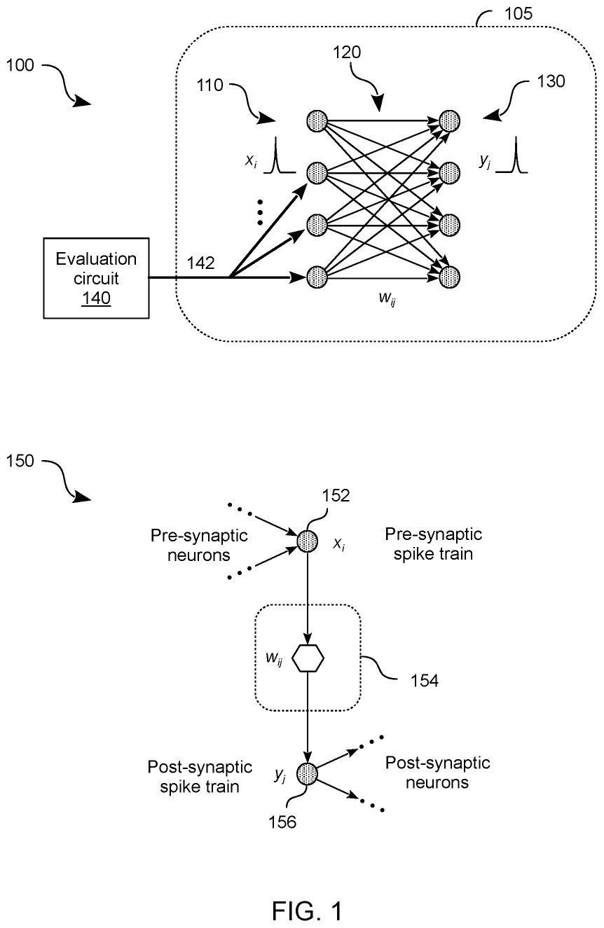

FIG. 1 illustrates an example diagram of a system 100 which comprises a spiking neural network 105, providing an illustration of connections 120 between a first set of nodes 110 (e.g., neurons) and a second set of nodes 130 (e.g., neurons). Some or all of a neural network (such as the spiking neural network 105) may be organized into multiple layers—e.g., including input layers and output layers. It will be understood that the spiking neural network 105 only depicts two layers and a small number of nodes, but other forms of neural networks may include a large number of variously configured nodes, layers, connections, and pathways.

Data that is provided into the neural network 105 may be first processed by synapses of input neurons. Interactions between the inputs, the neuron's synapses and the neuron itself govern whether an output is provided via an axon to another neuron's synapse. Modeling the synapses, neurons, axons, etc., may be accomplished in a variety of ways. In an example, neuromorphic hardware includes individual processing elements in a synthetic neuron (e.g., neurocore) and a messaging fabric to communicate outputs to other neurons. The determination of whether a particular neuron “fires” to provide data to a further connected neuron is dependent on the activation function applied by the neuron and the weight of the synaptic connection (e.g., wᵢⱼ) from neuron i (e.g., located in a layer of the first set of nodes 110) to neuron j (e.g., located in a layer of the second set of nodes 130). The input received by neuron i is depicted as value xᵢ, and the output produced from neuron j is depicted as value yⱼ. Thus, the processing conducted in a neural network is based on weighted connections, thresholds, and evaluations performed among the neurons, synapses, and other elements of the neural network.

In an example, the neural network 105 is established from a network of spiking neural network cores, with the neural network cores communicating via short packetized spike messages sent from core to core. For example, each neural network core may implement some number of primitive nonlinear temporal computing elements as neurons, so that when a neuron's activation exceeds some threshold level, it generates a spike message that is propagated to a fixed set of fanout neurons contained in destination cores. The network may distribute the spike messages to all destination neurons, and in response those neurons update their activations in a transient, time-dependent manner, similar to the operation of real biological neurons.

The neural network 105 further shows the receipt of a spike, represented in the value xᵢ, at neuron i in a first set of neurons (e.g., a neuron of the first set of nodes 110). The output of the neural network 105 is also shown as a spike, represented by the value yⱼ, which arrives at neuron j in a second set of neurons (e.g., a neuron of the first set of nodes 110) via a path established by the connections 120. In a spiking neural network all communication occurs over event-driven action potentials, or spikes. In an example, spikes convey no information other than the spike time as well as a source and destination neuron pair. Computations may variously occur in each a respective neuron as a result of the dynamic, nonlinear integration of weighted spike input using real-valued state variables. The temporal sequence of spikes generated by or for a particular neuron may be referred to as its “spike train.”

In an example of a spiking neural network, activation functions occur via spike trains, which means that time is a factor that has to be considered. Further, in a spiking neural network, each neuron may provide functionality similar to that of a biological neuron, as the artificial neuron receives its inputs via synaptic connections to one or more “dendrites” (part of the physical structure of a biological neuron), and the inputs affect an internal membrane potential of the artificial neuron “soma” (cell body). In a spiking neural network, the artificial neuron “fires” (e.g., produces an output spike), when its membrane potential crosses a firing threshold. Thus, the effect of inputs on a spiking neural network neuron operate to increase or decrease its internal membrane potential, making the neuron more or less likely to fire. Further, in a spiking neural network, input connections may be stimulatory or inhibitory. A neuron's membrane potential may also be affected by changes in the neuron's own internal state (“leakage”).

As described herein, some embodiments variously update a synaptic weight value based on a reward/penalty signal which is provided to a spiking neural network, wherein the reward/penalty signal is based on an evaluation of an earlier output signaling by the spiking neural network. For example, system 100 may further include or couple to hardware and/or executing software (such as the illustrative evaluation circuit 140 shown) which is coupled to receive output signaling such as that represented by the illustrative value yⱼ. Evaluation circuit 140 may include any of various processors, application specific integrated circuits (ASICs), field programmable gate arrays (FPGAs) and/or other circuitry configured to evaluate such output signaling—e.g., based on some predefined test criteria—to determine whether the output signaling is indicative of successful (or unsuccessful) processing by spiking neural network 105. A result of such evaluation may be variously communicated to some or all nodes of spiking neural network 105—e.g., via the illustrative reward/penalty signal 142 shown. In some embodiments, reward/penalty signal 142 is a predetermined spiking pattern which is communicated via synapses which are used in the generation of value yⱼ. Alternatively or in addition, one or more sideband signal paths may be dedicated to the communication of reward/penalty information such as that of reward/penalty signal 142.

FIG. 1 also illustrates an example inference path 150 in a spiking neural network, such as may be implemented by a form of the neural network 105 or other forms of neural networks. The inference path 150 of the neuron includes a pre-synaptic neuron 152, which is configured to produce a pre-synaptic spike train xᵢ representing a spike input. A spike train is a temporal sequence of discrete spike events, which provides a set of times specifying at which time a neuron fires.

As shown, the spike train xᵢ is produced by the neuron before the synapse (e.g., neuron 152), and the spike train xᵢ is evaluated for processing according to the characteristics of a synapse 154. For example, the synapse may apply one or more weights, e.g., weight wᵢⱼ, which are used in evaluating the data from the spike train xᵢ. Input spikes from the spike train xᵢ enter a synapse such as synapse 154 which has a weight wᵢⱼ. This weight scales what the impact of the presynaptic spike has on the post-synaptic neuron (e.g., neuron 156). If the integral contribution of all input connections to a post-synaptic neuron exceeds a threshold, then the post-synaptic neuron 156 will fire and produce a spike. As shown, yⱼ is the post-synaptic spike train produced by the neuron following the synapse (e.g., neuron 156) in response to some number of input connections. As shown, the post-synaptic spike train yⱼ is distributed from the neuron 156 to other post-synaptic neurons.

In some embodiments, nodes of spiking neural network 105 are of a Leaky Integrate-and-Fire (LIF) type—e.g., wherein, based on one or more spiking signals received at a given node j, the value of a membrane potential vₘ of that node j may spike and then decay over time. The spike and decay behavior of such a membrane potential vₘ may, for example, be according to the following:

$${τ}_{m} ( \frac{{dv}_{m}}{dt} ) ∝ - ( {v}_{m} - {v}_{rest} ) + {w}_{ij} \cdot {I}_{ij} + {J}_{b} , \qquad ( 1 )$$

where vᵣₑₛₜ is a resting potential toward which membrane potential vₘ is to settle, τₘ is a time constant for an exponential decay of membrane potential vₘ, wᵢⱼ is a synaptic weight of a synapse from another node i to node j, Iᵢⱼ is a spiking signal (or “spike train”) communicated to node j via said synapse, and J_{b} is a value that, for example, is based on a bias current or other signal provided to node j from some external node/source. The spiking neural network 105 may operate based on a pre-defined threshold voltage V_{threshold}, wherein the node j is configured to output a signal spike in response to its membrane potential vₘ being greater than V_{threshold}.

Certain features of various embodiments are described herein with reference to determining the value of a weight which is assigned to a synapse, wherein the synapse is coupled directly to each of node i and node j, and is to provide communication of a spike train from node i to node j. The notation “i” is used herein to indicate an association with node i, and the notation “j” is used to indicate association with node j. For example, node i may maintain a trace Xᵢ which is to provide a basis for determining—e.g., which is to equal—a spike train communicated from node i to node j via the synapse (which has a weight wᵢⱼ). Trace Xᵢ may be based in part on a signal Sᵢ which is received by node i—e.g., via a different synapse from a node other than node j. In such an embodiment, node j may maintain a trace Yⱼ which is to equal, or is otherwise to provide a basis for determining, another spike train communicated from node j (e.g., to a node other than node i). Trace Yⱼ may be based in part on trace Xᵢ—e.g., wherein trace Yⱼ is based on the spiked signal which is received from node i via the synapse.

In some embodiments, the value of synaptic weight wᵢⱼ may be determined based in part on a signal (referred to herein as a “reward/penalty signal”) which is provided to the spiking neural network based on an output from the spiking neural network. For example, an evaluation of such an output may determine whether (or not) satisfaction of some predefined test criteria is indicated. Based on the evaluation, a reward/penalty signal may be communicated to one or more nodes (e.g., including node j) of the spiking neural network. In response to an assertion of the reward/penalty signal, the one or more nodes may each perform a respective process to update a corresponding weight value.

For example, two traces Yⱼ₀, Yⱼ₁ may be maintained (at node j, for example) for use in determining whether and/or how weight wᵢⱼ is to be updated. Trace Yⱼ₀ may indicate, based at least in part on trace Xᵢ, a level of recent signal spiking activity at the node j—e.g., wherein spiking by trace Xᵢ is equal to, or is otherwise a basis for, spiking by the spike train which node i communicates to node j via the synapse. Similarly, spiking by trace Yⱼ₀ may be equal to, or otherwise provide a basis for, spiking by another spike train which node j communicates via a different synapse (e.g., to a node other than node i). More particularly, Yⱼ₀ may be the spiking of a post-synaptic neuron, such as post-synaptic spike train yⱼ in FIG. 1.

One or both of traces Xᵢ, Yⱼ₀ may be exhibit respective spike-and-decay signal characteristics. For example, a spike of trace Xᵢ, based on a spike of signal Sᵢ, may decay over time until some next spike of signal Sᵢ. Alternatively or in addition, a spike of trace Yⱼ₀, be based on a spike of trace Xᵢ, may decay over time until some next spike of trace Xᵢ. One or more other traces described herein may similarly exhibit respective spike-and-decay signal characteristics, in various embodiments.

In such an embodiment, trace Yⱼ₁ may be based on both trace Yⱼ₀ and a reward/penalty signal R. Trace Yⱼ₁ may indicate a level of correlation between a spiking pattern of trace Yⱼ₀ and an assertion of the reward/penalty signal R, where reward/penalty signal R indicates a result of an evaluation which is performed based on output signaling by the spiking neural network. For example, reward/penalty signal R may indicate whether, according to some predefined test criteria, processing performed with the spiking neural network has been a success (or alternatively, a failure). Spiking by trace Yⱼ₁ may be based on a predefined type of sequence which includes one or more signal spikes of trace Yⱼ₀ and one or more signal spikes of reward/penalty signal R. For example, node j may be configured to generate (or alternatively, prevent) signal spiking by trace Yⱼ₁ in response to detecting that a particular type of signal spiking by reward/penalty signal R is within some predetermined time window after a particular type of signal spiking by trace Yⱼ₀. Alternatively or in addition, node j may be configured to generate (or alternatively, prevent) some other signal spiking by trace Yⱼ₁ in response to detecting that a particular type of signal spiking by reward/penalty signal R has not occurred within such a predetermined time window. Node j may be configured to additionally or alternatively generate (or prevent) such other signal spiking by trace Yⱼ₁ in response to detecting that the particular type of signal spiking by reward/penalty signal R has occurred in the absence of any corresponding type of signal spiking by trace Yⱼ₀.

In such an embodiment, an update to weight wᵢⱼ may be based on trace Yⱼ₁—e.g., wherein the value of weight wᵢⱼ is increased based on a corresponding change to Yⱼ₁ (where the change to Yⱼ₁ is due to an indication by reward/penalty signal R of successful processing with the spiking neural network). Alternatively or in addition, the value of weight wᵢⱼ may be decreased based on a change to Yⱼ₁ which, in turn, is due to an indication by reward/penalty signal R of unsuccessful processing with the spiking neural network. In some embodiments, weight wᵢⱼ does not exhibit signal decay, but may instead maintain a given value/level until a subsequent change to Yⱼ₁ results in the value of weight wᵢⱼ being increased or decreased.

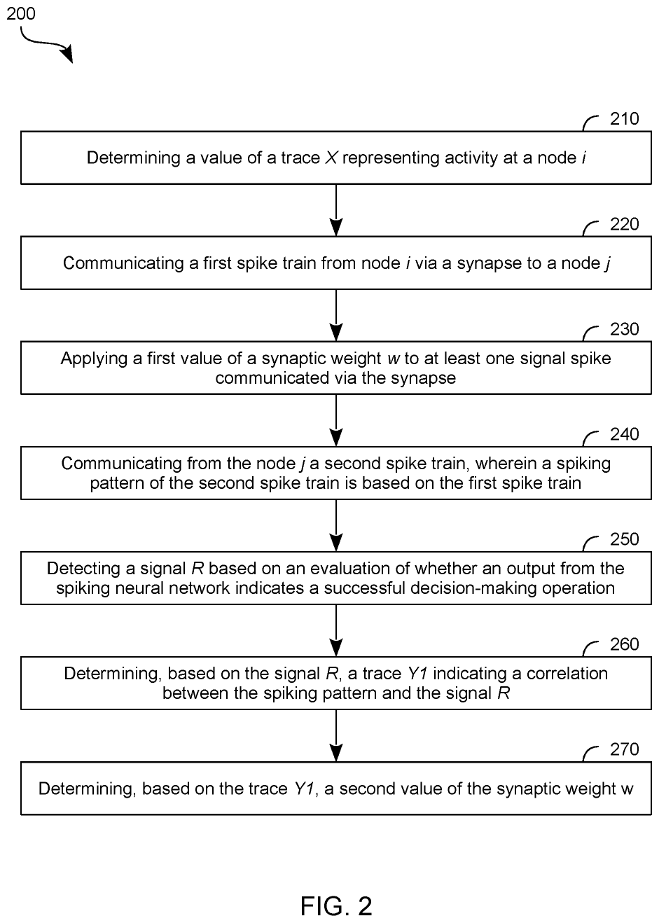

FIG. 2 shows features of a method 200 to operate a spiking neural network according to an embodiment. Method 200 is one example of an embodiment wherein reward/penalty signaling is provided to update one or more synaptic weight values—e.g., wherein the spiking neural network is configured to determine any of various state transitions of a state machine. Method 200 may be performed with neural network 105, for example.

As shown in FIG. 2, method 200 may include (at 210) determining a value of a trace X—e.g., the trace Xᵢ described elsewhere herein—which indicates a level of recent activity at a node i of a spiking neural network. The value of trace X may be determined at 210, for example, based at least in part on a spike train (such as signal Sᵢ) which is received at node i. Method 200 may further include (at 220) communicating a first spike train from the node i to a node j of the spiking neural network via a synapse coupled therebetween. Spiking of the first spike train may be the same as, or otherwise based upon, spiking of trace X.

In an embodiment, method further comprise (at 230) applying a first value of a synaptic weight w to at least one signal spike communicated via the synapse, the first value based on trace X. For example, the applying at 230 may include signal processing logic of node j amplifying the first spike train or otherwise multiplying a value which represents the first spike signal at least in part. Method 200 may further comprise (at 240) communicating from the node j a second spike train, wherein a spiking pattern of the second spike train is based on the first spike train. The second spike train may include or otherwise result in output signaling which is to be provided from the spiking neural network.

In some embodiments, method 200 further comprises (at 250) detecting a signal R provided to the spiking neural network, where the signal R—a reward/penalty signal—is based on an evaluation of whether, according to some predetermined criteria, an output from the spiking neural network indicates a successful decision-making operation. For example, the spiking neural network may be trained or otherwise configured to implement any of multiple state transitions of a state machine. Such a spiking neural network may receive input signaling which indicates a given state of a sequence of state transitions. In response to such input signaling, nodes of the spiking neural network may variously communicate spike trains each via a respective synapse. Such spike train communications may result in output signaling, from the spiking neural network, which indicates a decision which selects a state of the state machine that is to be a next successive state of the state sequence. Based on such output signaling, circuitry coupled to the spiking neural network may evaluate whether the decision has resulted in a violation of some test criteria by the state sequence and/or the satisfaction of some other test criteria by the state sequence.

Method 200 further comprises (at 260) determining, based on the signal R, a value of a trace Y1 which indicates a level of correlation between the spiking pattern and the signal R. Such correlation may be indicated by a proximity in time of spiking by the second spike train and associate spiking by signal R. For example, determining the value of trace Y1 at 260 may include detecting that a spiking pattern of the second spike train is followed, within a predefined time window, by a corresponding spiking pattern of the signal R. In one embodiment, a spike of trace Y1 is in response to a spike of the second spike train (and/or a spike of a trace on which the second spike train is based) being followed, within the predefined time window, by a spike of the signal R.

Method 200 may further comprise (at 270) determining, based on trace Y1, a second value of synaptic weight w. For example, output signaling from the spiking neural network may include a first spiking pattern which corresponds to a first decision-making operation of a sequence of decision-making operations with the spiking neural network. In such a scenario, spiking by signal R, based on an evaluation of the first spiking pattern, may alter trace Y1, resulting in a first change (e.g., a decrease) of synaptic weight w to a first value. In such an embodiment, the output from the spiking neural network may further include a second spiking pattern which corresponds to a second decision-making operation of the sequence of decision-making operations. In such a scenario, subsequent spiking by signal R, based on an evaluation of the second spiking pattern, may again alter trace Y1, resulting in a second change (e.g., an increase) of synaptic weight w from the first value.

In one embodiment, method 200 further comprises determining a value of a trace r which indicates a level of recent activity by the signal R. Node j may be configured, for example, to provide a spike of trace r in response to a spike of the signal R—e.g., wherein the spike of trace r decays over time. For example, trace r may increase in response to signal R indicating a reward for successful processing by the spiking neural network. Alternatively or in addition, trace r may decrease in response to signal R indicating a penalty for unsuccessful processing by the spiking neural network. In such an embodiment, determining the second value of synaptic weight w may be further based on trace r. For example, determining the value of trace Y1 at 260 based on the signal R may include detecting that a spiking pattern of the second spike train is followed, within a predefined time window, by a corresponding spiking pattern of the signal R. The spike of trace r—e.g., in combination with an associated spike in trace Y1—may result in a change to the value of weight w.

In some embodiments, determining the second value, at 270, based on trace Y1 includes determining the second value based on another trace E1—e.g., an eligibility trace—which itself is based on trace Y1. The value of such a trace E1 may indicate a level of susceptibility of synaptic weight w to being changed based on signal R. For example, traces E1, Y1 may correspond (respectively) to traces Eₐ, Yⱼ₁ in functional relationships f₂, f₃, f₄ which are shown in equations (2) through (4) as:

Eₐ=f₂{Yⱼ₁} (2)

r=f₃{R} (3)

wᵢⱼ=f₄{Eₐ, r} (4)

In such an embodiment, trace Eₐ may indicate a level of susceptibility of synaptic weight w to being changed based on the indication (by trace r, for example) that signal R as signaled a particular reward/penalty event. Trace Eₐ may exhibit spike-and-decay signal characteristics—e.g., wherein a spike of trace Eₐ is based on a particular one or more signal spikes of trace Yⱼ₁.

In some embodiments, such an eligibility trace Eₐ is one of two or more eligibility traces which are each used to determine the value of a weight wᵢⱼ, wherein at least one of the two or more eligibility traces is based on a value (such as that of trace Yⱼ₁) which indicates a level of correlation between signal spiking by node j and an assertion of a reward/penalty signal R. For example, method 200 further comprises determining a value of a trace E0 which indicates a level of correlation between the recent activity at the node i and the recent activity at the node j, wherein a spike of trace E1 is in response to respective spikes of trace E0 and trace Y1. In such an embodiment, trace E0 may indicate a level of susceptibility of trace E1 to being changed based on trace Y1.

For example, node j be trained or otherwise configured to maintain respective values of trace E0 and another trace Y0 (e.g., the trace Yⱼ referred to elsewhere) which indicates a level of recent activity at the node j. In such an embodiment, node j may provide a spike of trace E0 in response to respective spikes of trace X and trace Y0. Traces E0, E1, Y0, and Y1 may correspond, for example, to traces Eᵢⱼ¹, Eᵢⱼ², Yⱼ₀, and Yⱼ₁ (respectively) in functional relationships f₅ through f₈ which are shown in equations (5) through (8) as:

Eᵢⱼ¹=f₅{Xᵢ, Yⱼ₀} (5)

Eᵢⱼ²=f₆{Eᵢⱼ¹, Yⱼ₁} (6)

r=f₇{R} (7)

wᵢⱼ=f₈{Eᵢⱼ², r} (8)

In one such embodiment, a sensitivity of weight wᵢⱼ to change based on trace r may be based on value which is, in turn, is based on a product of the respective values of traces r, Eᵢⱼ². Alternatively or in addition, a sensitivity of trace Eᵢⱼ² to change based on trace Yⱼ₁ may be based on value which is, in turn, is based on a product of the respective values of traces Yⱼ₁, Eᵢⱼ¹. However, any of a variety of additional or alternative functions may be used each to determine the sensitivity of a respective parameter to change, according to an associated eligibility trace, in response to change by another respective parameter.

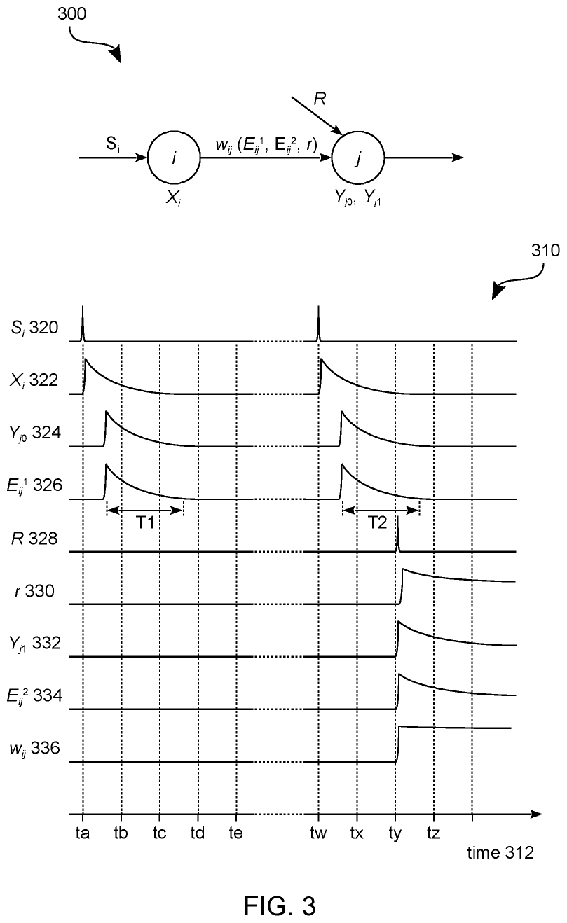

FIG. 3 shows a circuit 300 of a spiking neural network which is configured to update a synaptic weight value based on a reward/penalty signal according to an embodiment. FIG. 3 also shows a timing diagram 310 which illustrates, each with respect to a time axis 312, various plots each for a different respective trace, signal or weight which is determined with circuit 300. Parameters such as some or all of those shown in timing diagram 310 may be determined according to method 200—e.g., wherein operations of method 200 are performed with spiking neural network 105.

As shown in FIG. 3, circuit 300 includes nodes i, j and a synapse coupled therebetween, wherein a weight wᵢⱼ is assigned to the synapse. Timing diagram 310 shows respective plots 320, 322, 324, 326, 330, 332, 334 of spike train Sᵢ, and traces Xᵢ, Yⱼ₀, E¹ᵢⱼ, r, Yⱼ₁, and E²ᵢⱼ used to determine a value of synaptic weight wᵢⱼ. Timing diagram 310 also shows respective plots 328, 336 of a reward/penalty signal R and weight wᵢⱼ. To avoid obscuring certain features of various embodiments, the respective scales of plots shown in timing diagram 310 are normalized to unitless values in magnitude and time. Such scales may vary widely according to implementation-specific details, which are not limiting on some embodiments.

In the example embodiment shown, trace Xᵢ represents signaling activity at node i—e.g., wherein such signaling includes a pre-synaptic spike train Sᵢ communicated via another synapse. Trace Yⱼ₀ represents signaling activity at node j, includes a spike train, based on trace Xᵢ, which node j receives from node i via the synapse. Eligibility trace Eᵢⱼ¹ is indicative of a temporal proximity of spiking (e.g., including one or more signal spikes) by trace Xᵢ, to spiking by trace Yⱼ₀. For example, a level/value of trace Eᵢⱼ¹ may spike (and in some embodiments, subsequently decay) based on a proximity in time between a signal spike of trace Xᵢ—or of a spike train otherwise based on trace Xᵢ—and a subsequent signal spike of trace Yⱼ₀. The proximity in time may need to be within some threshold maximum time duration, for example.

Reward/penalty signal R, provided to the spiking neural network, may be based on an evaluation (based on some predefined test criteria) of earlier output signaling from the spiking neural network. Trace r—maintained at node j, for example—indicates a recency of signal spiking by reward/penalty signal R—e.g., wherein a level/value of trace r spikes (and in some embodiments, subsequently decays) in response to a spike of reward/penalty signal R. Trace Yⱼ₁ indicates a correlation of spiking activity by trace Yⱼ₀ with spiking activity by reward/penalty signal R. Eligibility trace E²ᵢⱼ is indicative of a concurrency or other temporal proximity of spiking by trace Yⱼ₁ with spiking by eligibility trace Eᵢⱼ¹.

Parameters which are variously shown in timing diagram 310 may have functional relationships f₉ through f₁₃ which, for example, are illustrated in equations (9) through (13) as follows:

Xᵢ=Xᵢ^{old}·e^{-(t}^{ₓ}^{/τ}^{ₓ}⁾+Sᵢ (9)

Eᵢⱼ¹=Eᵢⱼ^{1_old}·e^{-(t}^{ₑ₁}^{/τ}^{ₑ₁}⁾+XᵢYⱼ₀ (10)

Eᵢⱼ²=Eᵢⱼ^{2_old}·e^{-(t}^{ₑ₂}^{/τ}^{ₑ₂}⁾+BEᵢⱼ¹Yⱼ₁ (11)

r=r^{old}·e^{-(t}^{ᵣ}^{/τ}^{ᵣ}⁾+R (12)

wᵢⱼ=wᵢⱼ^{old}+Eᵢⱼ²*r (13)

As shown in equations (9) through (13), trace Xᵢ may decay over a length of time tₓ since an earlier value Xᵢ^{old} of trace Xᵢ—e.g., where trace Eᵢⱼ¹ is to decay over a length of time tₑ₁ since an earlier value Eᵢⱼ^{1_old} of trace Eᵢⱼ¹. Alternatively or in addition, trace Eᵢⱼ² may decay over a length of time tₑ₂ since an earlier value Eᵢⱼ^{2_old} of trace Eᵢⱼ²—e.g., where trace r may decay over a length of time tᵣ since an earlier value r^{old} of trace r. The various rates of decay by traces Xᵢ, Eᵢⱼ¹, Eᵢⱼ², and r may be according to respective time parameters τₓ, τₑ₁, τₑ₂, and τᵣ, for example.

In an illustrative scenario with one embodiment, multiple processing stages are performed with the spiking neural network which includes circuit 300—e.g., where each such processing stage includes or is followed by an evaluation stage to determine whether successful (or unsuccessful) processing is indicated by respective output signaling from the spiking neural network.

The first time period [ta-te] shown on time axis 312 may correspond to a result of a first processing stage—e.g., wherein a second time period [tw-tz] corresponds to a result of a second processing stage. During the first time period [ta-te], spiking by spike train Sᵢ may (for example) result in a spike by trace Xᵢ which, in turn, contributes to a spike by trace Yⱼ₀. As a result, a spike by eligibility trace Eᵢⱼ¹ may be provided at node j to indicate a proximity in time between the respective spiking of traces Xᵢ, Yⱼ₀. Such spiking by eligibility trace Eᵢⱼ¹ may increase a sensitivity of trace Eᵢⱼ¹ to change in response to spiking that might take place with trace Yⱼ₁—e.g., where any such spiking is limited to some predefined time window T1. In the example scenario shown, no such spiking by trace Yⱼ₁ takes place during the time window T1, and a subsequent decay of eligibility trace Eᵢⱼ¹ again decreases the sensitivity of trace Eᵢⱼ¹ to change based on trace Yⱼ₁.

During the second time period [tw-tz], further spiking by spike train Sᵢ may again result in spiking by trace Xᵢ and, in turn, another spike by trace Yⱼ₀. As during the first time period [ta-te], a proximity in time between the respective spiking of traces Xᵢ, Yⱼ₀ may result in a spike by eligibility trace Eᵢⱼ¹. However, whereas the first processing stage did not result in any reward event being indicated by reward/penalty signal R (and thus no spiking by spiking by trace Yⱼ₁ during time window T1), the second processing stage may result in spiking by reward/penalty signal R within a threshold maximum time window T2. In response, respective spikes by trace r and trace Yⱼ₁ may be variously asserted (e.g., due to spiking by trace Yⱼ₀ being sufficiently correlated with the spike by reward/penalty signal R). Based on a temporal proximity of respective spiking by trace Yⱼ₁ and eligibility trace Eᵢⱼ¹ with each other, a spike may be provided by eligibility trace Eᵢⱼ². Furthermore, a value of weight wᵢⱼ may change (in this example, increase) based on a temporal proximity of the spiking by trace Eᵢⱼ² with the spiking by trace r.

A spiking neural network according to some embodiment may be operable to facilitate the determining of a sequence of states (or “state sequence”)—e.g., wherein the spiking neural network implements at least in part a finite state machine (FSM) which includes such states and multiple transitions each from a respective current state to a respective next state. The sequence of states may satisfy some predefined criteria and, in some embodiments, may be relatively efficient, as compared to one or more alternative state sequences.

In one embodiment, a spiking neural network may be coupled to receive input signaling which specifies or otherwise indicates a given “current” state of the FSM. Such a spiking neural network may be trained or otherwise configured to generate output signaling, based on the received input signaling, which specifies or otherwise indicates an immediately successive “next” state of the state sequence which is to be determined. The spiking neural network may be configured, for example, to selectively indicate any one of the possible one or more states which, according to the FSM, is/are available to be the next state immediately succeeding the indicated current state. By way of illustration and not limitation, the spiking neural network may pseudo-randomly indicate one (and only one) such possible next state with the output signaling. However, in response to that same current state being indicated by other input signaling at a later time, the spiking neural network may provide output signaling which instead indicates a different one of the possible next states.

For example, the spiking neural network may be used to successively perform multiple processing stages which are each to determine, based on a respective current state of a sequence of states, a respective next stage of that sequence of states. For one such processing stage of the multiple processing stages, corresponding output signaling may indicate a respective next state which is to be indicated—by subsequent input signaling of a next successive processing stage of the multiple processing stages—as being the respective current state for that next successive processing stage. The multiple processing stages may thus successively determine respective states to be included in a given sequence of states.

In such an embodiment, a set of one or more decision-making rules may be applied to determine whether (or not) a state sequence—or at least a portion of the state sequence that has been identified to-date—satisfies some predefined test criteria for classifying a state sequence as being successful (or alternatively, unsuccessful). The test criteria may include one or more rules each associated with a respective one or more states. A given rule of such test criteria may specify that any state sequence must include (or alternatively, must omit) a particular one or more states—e.g., wherein the state sequence must include (or omit) at least one instance of a particular “sub-sequence” of states. For example, a rule may identify a given state (or sub-sequence of states) as being a “penalty” state (or sub-sequence) which results in a state sequence being identified as unsuccessful. Alternatively or in addition, a rule may identify a given state (or sub-sequence of states) as being a “reward” state (or sub-sequence) which may result in, or allow for, the state sequence being identified as successful—e.g., subject to the inclusion of any state/sub-sequence which is required to be in the sequence and/or the omission of any state/sub-sequence which is prohibited. In some embodiments, test criteria may identify one or more states each as being available to serve as an “initialization” state—e.g., wherein the state sequence must begin at one such initialization state. Similarly, the test criteria may identify one or more states each as being available to serve as a “completion” state which is to end the state sequence—e.g., wherein any transitioning to such a completion state will complete the determining of the state sequence.

Determining a sequence of state transitions of a FSM is just one example of an application, according to an embodiment, wherein a reward/penalty signal may be provided, based on output signaling from a spiking neural network, to update one or more synaptic weight values. The updating of such synaptic weight values may result in the spiking neural network learning to generate state sequences which are more efficient (e.g., as compared to previously-determined state sequences) and/or more likely to be identified as successful. However, any of a variety of other reward/penalty signals may be provided, in other embodiments, to update a synaptic weight value of a spiking neural network.

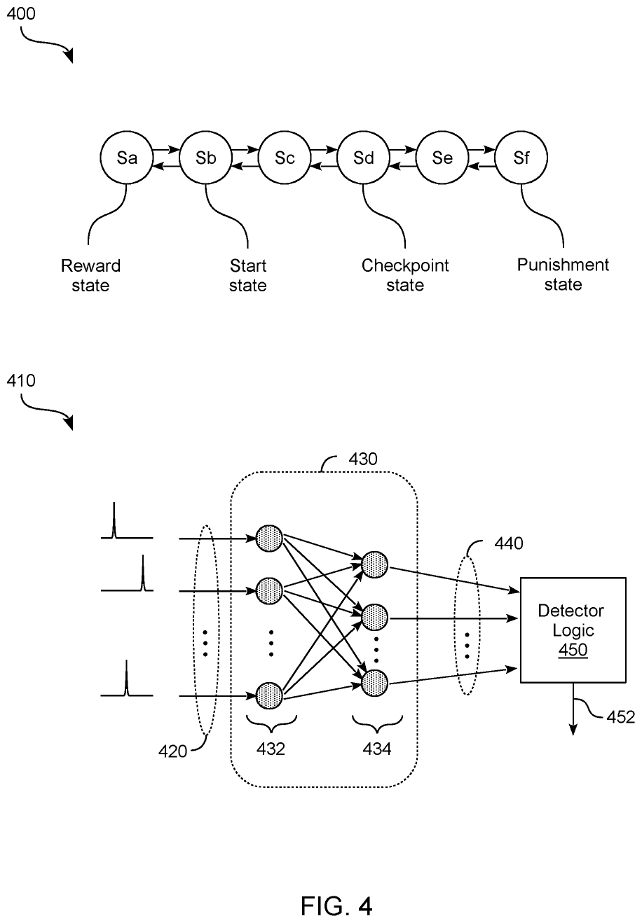

FIG. 4 shows features of a system 410 which is configured, according to an embodiment, to determine a state transition of a state machine. System 410 is one example of an embodiment wherein a synaptic weight value may be updated based on successful (or alternatively, unsuccessful) processing being indicated by output signaling from a spiking neural network. Such synaptic weight updating may be performed according to method 200—e.g., by a spiking neural network 430 of system 410 which includes features of spiking neural network 105.

Spiking neural network 430 includes input nodes 432 and output nodes 434, wherein synapses (and other nodes, in some embodiments) are variously coupled between input nodes 432 and output nodes 434. The particular number and configuration of the nodes and synapses shown for spiking neural network 430 are merely illustrative, and may instead provide any of a variety of other network topologies, in other embodiments. One or more spike trains 420 may be variously provided each to a respective one of input nodes 432—e.g., wherein one or more spike trains 420 specify or otherwise indicate a current state of a state sequence that is to be determined with the spiking neural network 430. By way of illustration and not limitation, one or more spike trains 420 may indicate a sub-sequence of a most recent two (or more) states of the state sequence—e.g., wherein the most recent two (or more) states includes a current state which is to be followed by an as-yet-undetermined next state of the state sequence. In such an embodiment, spiking neural network 430 may be trained to determine a next state of a sequence of states according to a finite state machine (such as the illustrative state machine 400 shown). Based on such training, processing of the one or more spike trains 420 by spiking neural network 430 may result in output signaling (e.g., including a spike train of the one or more output spike trains 440 shown) that indicates a particular state of the state machine which is to be the next state of the state sequence.

In one example embodiment, state machine 400 includes multiple states Sa, Sb, Sc, Sd, Se, Sf and various possible state transitions each between a respective two of such states. A set of one or more decision-making rules may define criteria according to which a given sequence—including various ones of states Sa, Sb, Sc, Sd, Se, Sf—is to be considered successful or unsuccessful. In combination with state machine 400, such test criteria may provide, at least in part, a model to be applied in any of a variety of system analysis problems related, for example, to logistics, computer networking, software emulation, and other such applications. Some embodiments are not limited to a particular type of application, system analysis problem, etc. for which spiking neural network 430 has been trained to provide a corresponding model.

In the example scenario illustrated by state machine 400, test criteria for identifying a successful sequence or an unsuccessful sequence (corresponding to a reward event/signal and a penalty event/signal, respectively) includes a requirement that the sequence state at state Sa and a requirement that the sequence include state Sd. Furthermore, the test criteria identifies state Sa as being a reward state, wherein inclusion of state Sa in the sequence enables—e.g., contingent upon the sequence having also included an instance of the required “checkpoint” state Sd—the communication of a reward signal to spiking neural network 430. Further still, the test criteria identifies state Sf as being a punishment state, wherein inclusion of state Sf in the sequence requires the communication of a penalty signal to spiking neural network 430.

The output signaling, provided by spiking neural network 440 based on input signaling 420, may be received by detector logic 450 of system 410—e.g., wherein detector logic 450 corresponds functionally to evaluation circuit 140. Based on such output signaling, detector logic 450 may determine a state of state machine 400 which spiking neural network 430 has chosen to append as a next state of the state sequence being determined.

Detector logic 450 may evaluate whether the state sequence, as determined to-date, satisfies (or violates) any test criteria for classifying the sequence as successful (of unsuccessful) of the sequence. Based on a result of such evaluation, detector logic 450 may communicate to spiking neural network 430 a reward/penalty signal 452 (e.g., the signal R described elsewhere herein) which indicates one of a reward event and a penalty event. One or more synaptic weights of spiking neural network 430 may be updated based on the indicating of such a reward event or penalty event with an assertion of reward/penalty signal 452.

Where the state sequence, as determined to-date, has been identified as successful (or alternatively, as unsuccessful), the state sequence may be considered complete—e.g., wherein spiking neural network 430 is then used in a next set of processing stages to attempt to determine a new state sequence which satisfies the test criteria. Where the state sequence, as determined to-date, has not been identified as an unsuccessful, another processing stage may be performed with spiking neural network 430 to determine yet another subsequent state to append to the state sequence. For example, the most recently determined next state of the sequence may be represented by a next round of input signaling 420 as the current state of a most recent two (or more) states. Detector logic 450 may then receive and evaluate later output signaling from spiking neural network 430 to identify a next state of the state sequence. The incrementally longer state sequence may then be evaluated by spiking neural network 430 to detect whether, according to the test criteria, a reward event or a penalty event is to be indicated to spiking neural network 430 using signal 452. Such an evaluation may result in additional adjusting of one or more network nodes—e.g., whereby spiking neural network learns to improve its selection of a next state.

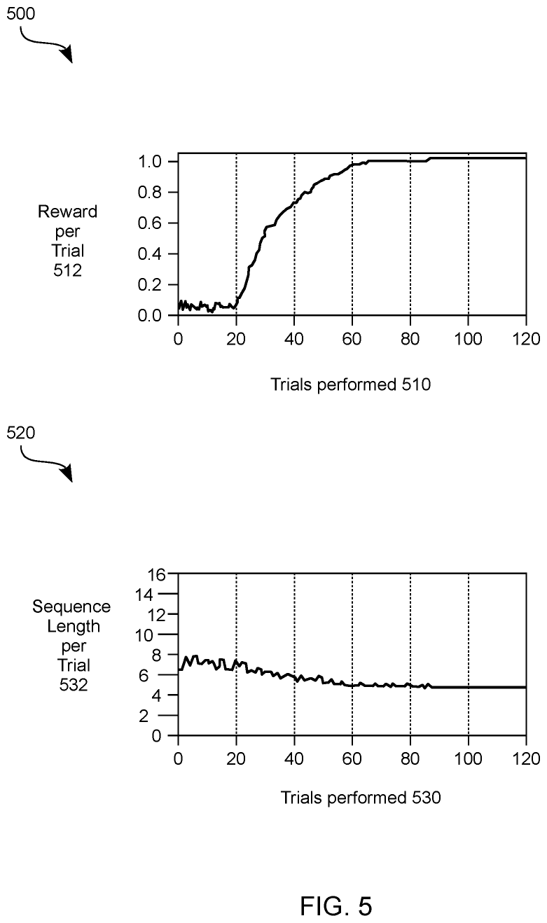

FIG. 5 shows graphs 500, 520 illustrating respective performance metrics for a binary decision-making process with a spiking neural network according to an embodiment. Graphs 500, 520 represent the efficiency of multiple processing stages which are performed with a spiking neural network, according to one embodiment, to identify a sequence of states of state machine 400.

More particularly, graph 500 shows a domain axis 510 representing multiple trials, in the order they were performed, which are each an attempt to determine a corresponding state sequence which satisfies the criteria for a successful state sequence with state machine 400. Some or all such multiple trials may each include respective processing stages which are each to variously determine a next state to include in the corresponding state sequence. Graph 500 also shows a range axis 512 representing reward values which are each associated with a corresponding one of the multiple trials. A reward for a given trial may represent, for example, a normalized (unitless) value which is a function of both a total number of states of the corresponding state sequence and a reward/penalty result associated with the corresponding state sequence. As shown in graph 500, significant improvements in the reward values begin to appear at about the twentieth trial, where at least some very efficient state sequence has been identified by around the sixtieth trial.

Similar to graph 500, graph 520 shows a domain axis 530 representing multiple trials in the order they were performed (e.g., the same trials as those represented by axis 510). Graph 520 also shows a range axis 532 representing the respective lengths (in total number of states) of the corresponding state sequences for each such trial. As shown in graph 520, the lengths of state sequences is quickly limited to not more than eight states, and reaches an optimal length (in this example, a length of six states) by around the sixtieth trial. The results shown by graphs 500, 520 are a significant improvement over techniques which are used conventionally in other types of neural network learning.

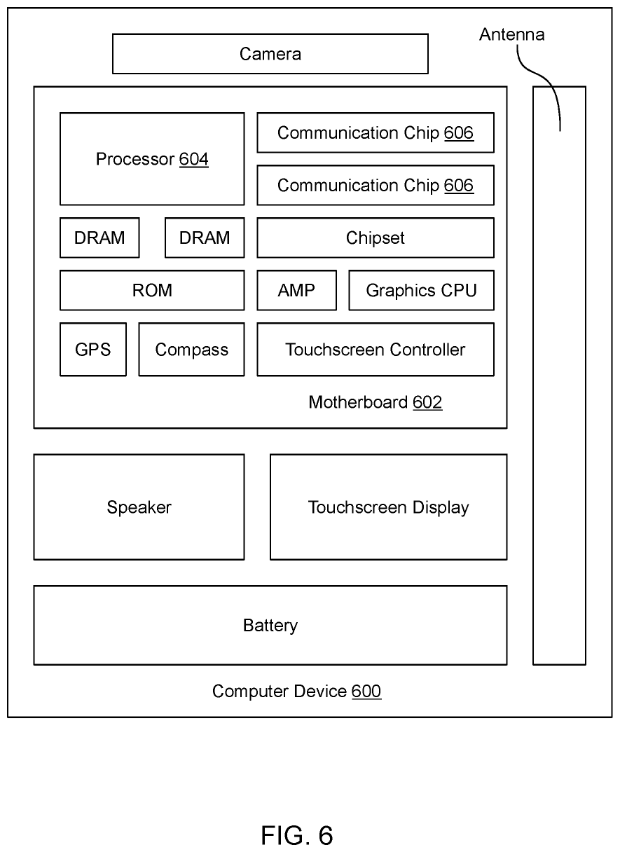

FIG. 6 illustrates a computing device 600 in accordance with one embodiment. The computing device 600 houses a board 602. The board 602 may include a number of components, including but not limited to a processor 604 and at least one communication chip 606. The processor 604 is physically and electrically coupled to the board 602. In some implementations the at least one communication chip 606 is also physically and electrically coupled to the board 602. In further implementations, the communication chip 606 is part of the processor 604.

Depending on its applications, computing device 600 may include other components that may or may not be physically and electrically coupled to the board 602. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 606 enables wireless communications for the transfer of data to and from the computing device 600. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 606 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 600 may include a plurality of communication chips 606. For instance, a first communication chip 606 may be dedicated to shorter range wireless communications such as Wi-Fi and Bluetooth and a second communication chip 606 may be dedicated to longer range wireless communications such as GPS, EDGE, GPRS, CDMA, WiMAX, LTE, Ev-DO, and others.

The processor 604 of the computing device 600 includes an integrated circuit die packaged within the processor 604. The term “processor” may refer to any device or portion of a device that processes electronic data from registers and/or memory to transform that electronic data into other electronic data that may be stored in registers and/or memory. The communication chip 606 also includes an integrated circuit die packaged within the communication chip 606.

In various implementations, the computing device 600 may be a laptop, a netbook, a notebook, an ultrabook, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the computing device 600 may be any other electronic device that processes data.

Some embodiments may be provided as a computer program product, or software, that may include a machine-readable medium having stored thereon instructions, which may be used to program a computer system (or other electronic devices) to perform a process according to an embodiment. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

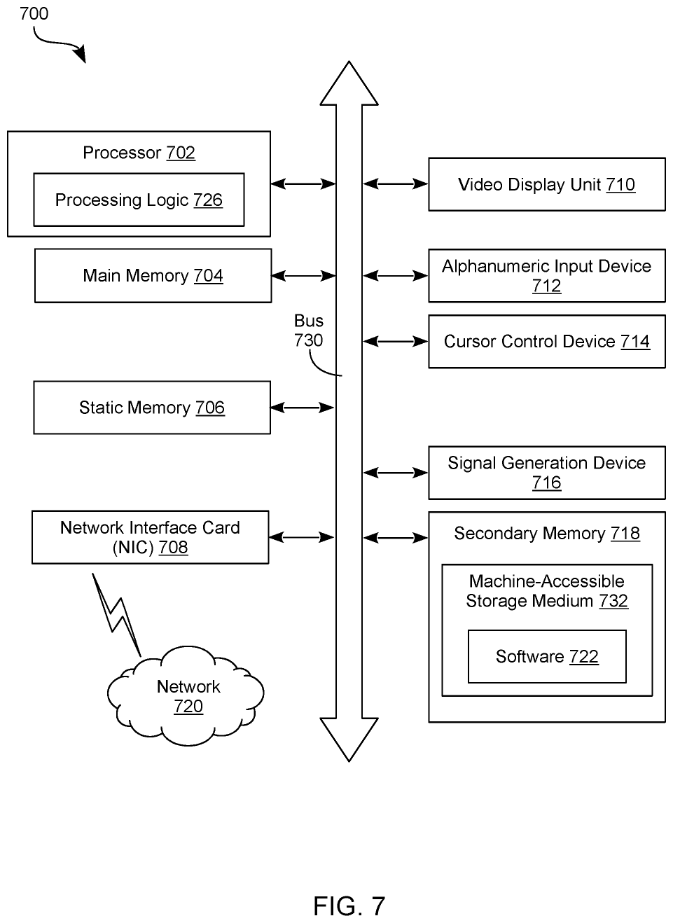

FIG. 7 illustrates a diagrammatic representation of a machine in the exemplary form of a computer system 700 within which a set of instructions, for causing the machine to perform any one or more of the methodologies described herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies described herein.

The exemplary computer system 700 includes a processor 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a secondary memory 718 (e.g., a data storage device), which communicate with each other via a bus 730.

Processor 702 represents one or more general-purpose processing devices such as a microprocessor, central processing unit, or the like. More particularly, the processor 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 702 may also be one or more special-purpose processing devices such as an application specific integrated circuit (ASIC), a field programmable gate array (FPGA), a digital signal processor (DSP), network processor, or the like. Processor 702 is configured to execute the processing logic 726 for performing the operations described herein.

The computer system 700 may further include a network interface device 708. The computer system 700 also may include a video display unit 710 (e.g., a liquid crystal display (LCD), a light emitting diode display (LED), or a cathode ray tube (CRT)), an alphanumeric input device 712 (e.g., a keyboard), a cursor control device 714 (e.g., a mouse), and a signal generation device 716 (e.g., a speaker).

The secondary memory 718 may include a machine-accessible storage medium (or more specifically a computer-readable storage medium) 732 on which is stored one or more sets of instructions (e.g., software 722) embodying any one or more of the methodologies or functions described herein. The software 722 may also reside, completely or at least partially, within the main memory 704 and/or within the processor 702 during execution thereof by the computer system 700, the main memory 704 and the processor 702 also constituting machine-readable storage media. The software 722 may further be transmitted or received over a network 720 via the network interface device 708.

While the machine-accessible storage medium 732 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any of one or more embodiments. The term “machine-readable storage medium” shall accordingly be taken to include, but not be limited to, solid-state memories, and optical and magnetic media.

Example 1 is a computer device comprising circuitry to determine a value of a trace X which indicates a level of recent activity at a node i of a spiking neural network, communicate a first spike train from the node i to a node j of the spiking neural network via a synapse coupled therebetween, apply a first value of a synaptic weight w to at least one signal spike communicated via the synapse, the first value based on the trace X, and communicate from the node j a second spike train, wherein a spiking pattern of the second spike train is based on the first spike train. The circuitry is further to detect a signal R provided to the spiking neural network, the signal R based on an evaluation of whether, according to a predetermined criteria, an output from the spiking neural network indicates a successful decision-making operation, determine, based on the signal R, a value of a trace Y1 which indicates a level of correlation between the spiking pattern and the signal R, and determine, based on the trace Y1, a second value of the synaptic weight w.

In Example 2, the subject matter of any one or more of Examples 1 optionally includes wherein circuitry to determine the value of the trace Y1 based on the signal R includes circuitry to detect that a spiking pattern of the second spike train is followed, within a predefined time window, by a corresponding spiking pattern of the signal R.

In Example 3, the subject matter of Example 2 optionally includes wherein a spike of the trace Y1 is to be in response to a spike of the second spike train which is followed, within the predefined time window, by a spike of the signal R.

In Example 4, the subject matter of any one or more of Examples 1 through 2 optionally includes the computer device further comprising circuitry to determine a value of a trace r which indicates a level of recent activity by the signal R, wherein a spike of the trace r is in response to a spike of the signal R, wherein the spike of the trace r decays over time, wherein circuitry is to determine the second value of the synaptic weight w further based on the trace r.

In Example 5, the subject matter of Example 4 optionally includes wherein circuitry to determine the value of the trace Y1 based on the signal R includes circuitry to detect that a spiking pattern of the second spike train is followed, within a predefined time window, by a corresponding spiking pattern of the signal R.

In Example 6, the subject matter of any one or more of Examples 1, 2 and 4 optionally includes the computer device further comprising circuitry to determine, based on trace Y1, a value of a trace E1 which indicates a level of susceptibility of the synaptic weight w to being changed based on signal R, wherein circuitry to determine the second value of the synaptic weight w based on trace Y1 includes circuitry to determine the second value of the synaptic weight w based on trace E1.

In Example 7, the subject matter of Example 6 optionally includes the computer device further comprising circuitry to determine a value of a trace E0 which indicates a level of correlation between the recent activity at the node i and the recent activity at the node j, wherein a spike of the trace E1 is in response to respective spikes of the trace E0 and the trace Y1.

In Example 8, the subject matter of Example 7 optionally includes wherein a spike of the trace E0 is in response to respective spikes of the trace X and a trace Y0 which indicates a level of recent activity at the node j.

In Example 9, the subject matter of Example 6 optionally includes the computer device further comprising circuitry to determine a value of a trace Y0 which indicates a level of recent activity at the node j, wherein a spike of the trace Y0 is in response to a spike of a first spike train, wherein circuitry is to determine the value of the trace E1 further based on trace Y0.

In Example 10, the subject matter of any one or more of Examples 1, 2 and 4 optionally includes the computer device further comprising further comprising circuitry to receive a third spike train at node i, wherein the first spike train is based on the third spike train, wherein a spike of the trace X is in response to a spike of the third spike train, and wherein the spike of the trace X decays over time.

In Example 11, the subject matter of any one or more of Examples 1, 2 and 4 optionally includes wherein the output from the spiking neural network is to include a first spiking pattern which corresponds to a first decision-making operation of a sequence of decision-making operations with the spiking neural network, wherein the first spiking pattern is to result in a first change of the synaptic weight w to a first value, and a second spiking pattern which corresponds to a second decision-making operation of the sequence of decision-making operations, wherein the second spiking pattern results in a second change of the synaptic weight w from the first value.

Example 12 is at least one machine readable medium including instructions that, when executed by a machine, cause the machine to perform operations with a spiking neural network, the operations comprising determining a value of a trace X which indicates a level of recent activity at a node i of a spiking neural network, communicating a first spike train from the node i to a node j of the spiking neural network via a synapse coupled therebetween, applying a first value of a synaptic weight w to at least one signal spike communicated via the synapse, the first value based on the trace X, and communicating from the node j a second spike train, wherein a spiking pattern of the second spike train is based on the first spike train. The operations further include detecting a signal R provided to the spiking neural network, the signal R based on an evaluation of whether, according to a predetermined criteria, an output from the spiking neural network indicates a successful decision-making operation, determining, based on the signal R, a value of a trace Y1 which indicates a level of correlation between the spiking pattern and the signal R, and determining, based on the trace Y1, a second value of the synaptic weight w.

In Example 13, the subject matter of Example 12 optionally includes wherein determining the value of the trace Y1 based on the signal R includes detecting that a spiking pattern of the second spike train is followed, within a predefined time window, by a corresponding spiking pattern of the signal R.

In Example 14, the subject matter of Example 13 optionally includes wherein a spike of the trace Y1 is to be in response to a spike of the second spike train which is followed, within the predefined time window, by a spike of the signal R.

In Example 15, the subject matter of any one or more of Examples 12 and 13 optionally includes the operations further comprising determining a value of a trace r which indicates a level of recent activity by the signal R, wherein a spike of the trace r is in response to a spike of the signal R, wherein the spike of the trace r decays over time, wherein determining the second value of the synaptic weight w is further based on the trace r.

In Example 16, the subject matter of Example 15 optionally includes wherein determining the value of the trace Y1 based on the signal R includes detecting that a spiking pattern of the second spike train is followed, within a predefined time window, by a corresponding spiking pattern of the signal R.

In Example 17, the subject matter of any one or more of Examples 12, 13 and 15 optionally includes the operations further comprising determining, based on trace Y1, a value of a trace E1 which indicates a level of susceptibility of the synaptic weight w to being changed based on signal R, wherein determining the second value of the synaptic weight w based on trace Y1 includes determining the second value of the synaptic weight w based on trace E1.

In Example 18, the subject matter of Example 17 optionally includes the operations further comprising determining a value of a trace E0 which indicates a level of correlation between the recent activity at the node i and the recent activity at the node j, wherein a spike of the trace E1 is in response to respective spikes of the trace E0 and the trace Y1.

In Example 19, the subject matter of Example 18 optionally includes wherein a spike of the trace E0 is in response to respective spikes of the trace X and a trace Y0 which indicates a level of recent activity at the node j.

In Example 20, the subject matter of Example 17 optionally includes the operations further comprising determining a value of a trace Y0 which indicates a level of recent activity at the node j, wherein a spike of the trace Y0 is in response to a spike of a first spike train, wherein determining the value of the trace E1 is further based on trace Y0.

In Example 21, the subject matter of any one or more of Examples 12, 13 and 15 optionally includes the operations further comprising receiving a third spike train at node i, wherein the first spike train is based on the third spike train, wherein a spike of the trace X is in response to a spike of the third spike train, and wherein the spike of the trace X decays over time.

In Example 22, the subject matter of any one or more of Examples 12, 13 and 15 optionally includes wherein the output from the spiking neural network is to include a first spiking pattern which corresponds to a first decision-making operation of a sequence of decision-making operations with the spiking neural network, wherein the first spiking pattern is to result in a first change of the synaptic weight w to a first value, and a second spiking pattern which corresponds to a second decision-making operation of the sequence of decision-making operations, wherein the second spiking pattern results in a second change of the synaptic weight w from the first value.

Example 23 is a method at a spiking neural network, the method comprising determining a value of a trace X which indicates a level of recent activity at a node i of a spiking neural network, communicating a first spike train from the node i to a node j of the spiking neural network via a synapse coupled therebetween, applying a first value of a synaptic weight w to at least one signal spike communicated via the synapse, the first value based on the trace X, and communicating from the node j a second spike train, wherein a spiking pattern of the second spike train is based on the first spike train. The method further comprises detecting a signal R provided to the spiking neural network, the signal R based on an evaluation of whether, according to a predetermined criteria, an output from the spiking neural network indicates a successful decision-making operation, determining, based on the signal R, a value of a trace Y1 which indicates a level of correlation between the spiking pattern and the signal R, and determining, based on the trace Y1, a second value of the synaptic weight w.

In Example 24, the subject matter of Example 23 optionally includes wherein determining the value of the trace Y1 based on the signal R includes detecting that a spiking pattern of the second spike train is followed, within a predefined time window, by a corresponding spiking pattern of the signal R.

In Example 25, the subject matter of Example 24 optionally includes wherein a spike of the trace Y1 is to be in response to a spike of the second spike train which is followed, within the predefined time window, by a spike of the signal R.

In Example 26, the subject matter of any one or more of Examples 23 and 24 optionally includes the method further comprising determining a value of a trace r which indicates a level of recent activity by the signal R, wherein a spike of the trace r is in response to a spike of the signal R, wherein the spike of the trace r decays over time, wherein determining the second value of the synaptic weight w is further based on the trace r.

In Example 27, the subject matter of Example 26 optionally includes wherein determining the value of the trace Y1 based on the signal R includes detecting that a spiking pattern of the second spike train is followed, within a predefined time window, by a corresponding spiking pattern of the signal R.

In Example 28, the subject matter of any one or more of Examples 23, 24 and 26 optionally includes the method further comprising determining, based on trace Y1, a value of a trace E1 which indicates a level of susceptibility of the synaptic weight w to being changed based on signal R, wherein determining the second value of the synaptic weight w based on trace Y1 includes determining the second value of the synaptic weight w based on trace E1.

In Example 29, the subject matter of Example 28 optionally includes the method further comprising determining a value of a trace E0 which indicates a level of correlation between the recent activity at the node i and the recent activity at the node j, wherein a spike of the trace E1 is in response to respective spikes of the trace E0 and the trace Y1.

In Example 30, the subject matter of Example 29 optionally includes wherein a spike of the trace E0 is in response to respective spikes of the trace X and a trace Y0 which indicates a level of recent activity at the node j.

In Example 31, the subject matter of Example 28 optionally includes the method further comprising determining a value of a trace Y0 which indicates a level of recent activity at the node j, wherein a spike of the trace Y0 is in response to a spike of a first spike train, wherein determining the value of the trace E1 is further based on trace Y0.

In Example 32, the subject matter of any one or more of Examples 23, 24 and 26 optionally includes the method further comprising receiving a third spike train at node i, wherein the first spike train is based on the third spike train, wherein a spike of the trace X is in response to a spike of the third spike train, and wherein the spike of the trace X decays over time.

In Example 33, the subject matter of any one or more of Examples 23, 24 and 26 optionally includes wherein the output from the spiking neural network is to include a first spiking pattern which corresponds to a first decision-making operation of a sequence of decision-making operations with the spiking neural network, wherein the first spiking pattern is to result in a first change of the synaptic weight w to a first value, and a second spiking pattern which corresponds to a second decision-making operation of the sequence of decision-making operations, wherein the second spiking pattern results in a second change of the synaptic weight w from the first value.

Techniques and architectures for updating synaptic weight values with a spiking neural network are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

1-25. (canceled)

26. A computer device for reward-based training of a spiking neural network, the computer device comprising circuitry to:
determine a value of a trace X which indicates a level of recent activity at a node i of a spiking neural network;
communicate a first spike train from the node i to a node j of the spiking neural network via a synapse coupled therebetween;
apply a first value of a synaptic weight w to at least one signal spike communicated via the synapse, the first value based on the trace X;
communicate from the node j a second spike train, wherein a spiking pattern of the second spike train is based on the first spike train;
detect a signal R provided to the spiking neural network, the signal R based on an evaluation of whether, according to a predetermined criteria, an output from the spiking neural network indicates a successful decision-making operation;
determine, based on the signal R, a value of a trace Y1 which indicates a level of correlation between the spiking pattern and the signal R; and
determine, based on the trace Y1, a second value of the synaptic weight w.

27. The computer device of claim 26, wherein circuitry to determine the value of the trace Y1 based on the signal R includes circuitry to detect that a spiking pattern of the second spike train is followed, within a predefined time window, by a corresponding spiking pattern of the signal R.

28. The computer device of claim 27, wherein a spike of the trace Y1 is to be in response to a spike of the second spike train which is followed, within the predefined time window, by a spike of the signal R.

29. The computer device of claim 26, further comprising circuitry to determine a value of a trace r which indicates a level of recent activity by the signal R, wherein a spike of the trace r is in response to a spike of the signal R, wherein the spike of the trace r decays over time, wherein circuitry is to determine the second value of the synaptic weight w further based on the trace r.

30. The computer device of claim 29, wherein circuitry to determine the value of the trace Y1 based on the signal R includes circuitry to detect that a spiking pattern of the second spike train is followed, within a predefined time window, by a corresponding spiking pattern of the signal R.

31. The computer device of claim 26, further comprising circuitry to determine, based on trace Y1, a value of a trace E1 which indicates a level of susceptibility of the synaptic weight w to being changed based on signal R, wherein circuitry to determine the second value of the synaptic weight w based on trace Y1 includes circuitry to determine the second value of the synaptic weight w based on trace E1.

32. The computer device of claim 31, further comprising circuitry to determine a value of a trace E0 which indicates a level of correlation between the recent activity at the node i and the recent activity at the node j, wherein a spike of the trace E1 is in response to respective spikes of the trace E0 and the trace Y1.

33. The computer device of claim 32, wherein a spike of the trace E0 is in response to respective spikes of the trace X and a trace Y0 which indicates a level of recent activity at the node j.

34. The computer device of claim 31, further comprising circuitry to determine a value of a trace Y0 which indicates a level of recent activity at the node j, wherein a spike of the trace Y0 is in response to a spike of a first spike train, wherein circuitry is to determine the value of the trace E1 further based on trace Y0.

35. The computer device of claim 26, further comprising circuitry to receive a third spike train at node i, wherein the first spike train is based on the third spike train, wherein a spike of the trace X is in response to a spike of the third spike train, and wherein the spike of the trace X decays over time.

36. The computer device of claim 26, wherein the output from the spiking neural network is to include:
a first spiking pattern which corresponds to a first decision-making operation of a sequence of decision-making operations with the spiking neural network, wherein the first spiking pattern is to result in a first change of the synaptic weight w to a first value; and
a second spiking pattern which corresponds to a second decision-making operation of the sequence of decision-making operations, wherein the second spiking pattern results in a second change of the synaptic weight w from the first value.

37. At least one machine readable medium including instructions that, when executed by a machine, cause the machine to perform operations for reward-based training of a spiking neural network, the operations comprising:
determining a value of a trace X which indicates a level of recent activity at a node i of a spiking neural network;
communicating a first spike train from the node i to a node j of the spiking neural network via a synapse coupled therebetween;
applying a first value of a synaptic weight w to at least one signal spike communicated via the synapse, the first value based on the trace X;
communicating from the node j a second spike train, wherein a spiking pattern of the second spike train is based on the first spike train;
detecting a signal R provided to the spiking neural network, the signal R based on an evaluation of whether, according to a predetermined criteria, an output from the spiking neural network indicates a successful decision-making operation;
determining, based on the signal R, a value of a trace Y1 which indicates a level of correlation between the spiking pattern and the signal R; and
determining, based on the trace Y1, a second value of the synaptic weight w.

38. The at least one machine readable medium of claim 37, wherein determining the value of the trace Y1 based on the signal R includes detecting that a spiking pattern of the second spike train is followed, within a predefined time window, by a corresponding spiking pattern of the signal R.

39. The at least one machine readable medium of claim 38, wherein a spike of the trace Y1 is to be in response to a spike of the second spike train which is followed, within the predefined time window, by a spike of the signal R.

40. The at least one machine readable medium of claim 37, the operations further comprising determining a value of a trace r which indicates a level of recent activity by the signal R, wherein a spike of the trace r is in response to a spike of the signal R, wherein the spike of the trace r decays over time, wherein determining the second value of the synaptic weight w is further based on the trace r.

41. The at least one machine readable medium of claim 40, wherein determining the value of the trace Y1 based on the signal R includes detecting that a spiking pattern of the second spike train is followed, within a predefined time window, by a corresponding spiking pattern of the signal R.

42. The at least one machine readable medium of claim 37, the operations further comprising determining, based on trace Y1, a value of a trace E1 which indicates a level of susceptibility of the synaptic weight w to being changed based on signal R, wherein determining the second value of the synaptic weight w based on trace Y1 includes determining the second value of the synaptic weight w based on trace E1.

43. The at least one machine readable medium of claim 42, the operations further comprising determining a value of a trace E0 which indicates a level of correlation between the recent activity at the node i and the recent activity at the node j, wherein a spike of the trace E1 is in response to respective spikes of the trace E0 and the trace Y1.

44. The at least one machine readable medium of claim 43, wherein a spike of the trace E0 is in response to respective spikes of the trace X and a trace Y0 which indicates a level of recent activity at the node j.

45. The at least one machine readable medium of claim 42, the operations further comprising determining a value of a trace Y0 which indicates a level of recent activity at the node j, wherein a spike of the trace Y0 is in response to a spike of a first spike train, wherein determining the value of the trace E1 is further based on trace Y0.

46. The at least one machine readable medium of claim 37, the operations further comprising receiving a third spike train at node i, wherein the first spike train is based on the third spike train, wherein a spike of the trace X is in response to a spike of the third spike train, and wherein the spike of the trace X decays over time.

47. The at least one machine readable medium of claim 37, wherein the output from the spiking neural network is to include:
a first spiking pattern which corresponds to a first decision-making operation of a sequence of decision-making operations with the spiking neural network, wherein the first spiking pattern is to result in a first change of the synaptic weight w to a first value; and
a second spiking pattern which corresponds to a second decision-making operation of the sequence of decision-making operations, wherein the second spiking pattern results in a second change of the synaptic weight w from the first value.

48. A method for reward-based training of a spiking neural network, the method comprising:
determining a value of a trace X which indicates a level of recent activity at a node i of a spiking neural network;
communicating a first spike train from the node i to a node j of the spiking neural network via a synapse coupled therebetween;
applying a first value of a synaptic weight w to at least one signal spike communicated via the synapse, the first value based on the trace X;
communicating from the node j a second spike train, wherein a spiking pattern of the second spike train is based on the first spike train;
detecting a signal R provided to the spiking neural network, the signal R based on an evaluation of whether, according to a predetermined criteria, an output from the spiking neural network indicates a successful decision-making operation;
determining, based on the signal R, a value of a trace Y1 which indicates a level of correlation between the spiking pattern and the signal R; and
determining, based on the trace Y1, a second value of the synaptic weight w.

49. The method of claim 48, wherein determining the value of the trace Y1 based on the signal R includes detecting that a spiking pattern of the second spike train is followed, within a predefined time window, by a corresponding spiking pattern of the signal R.

50. The method of claim 49, wherein a spike of the trace Y1 is to be in response to a spike of the second spike train which is followed, within the predefined time window, by a spike of the signal R.
